(19) United States
(12) Patent Application Publication
(10) Pub. No.: US 2016/0095442 A1
(43) Pub. Date: Apr. 7, 2016

(54) COMBINATION COMPRISING A SEAT, A PORTABLE DEVICE WHICH COMPRISES A MOVEMENT SENSOR AND AN EVALUATION DEVICE AND A METHOD WHICH CAN BE CARRIED OUT USING THE COMBINATION

(71) Applicant: Wilkhahn Wilkening + Hahne GmbH + Co., Munster (DE)

(72) Inventor: Carsten Gehner, Hannover (DE)

(21) Appl. No.: 14/873,511

(22) Filed: Oct. 2, 2015

(30) Foreign Application Priority Data
Oct. 6, 2014 (DE) 10 2014 114 459.7

(51) Int. Cl. A47C 3/00; G05B 15/02; A47C 1/02; A47C 3/18; A47C 7/40

(52) U.S. Cl. CPC A47C 3/00; A47C 3/18; A47C 7/40; A47C 1/02; G05B 15/02

(57) ABSTRACT

A combination of a seat and a portable device including at least one movement sensor and an evaluation device is characterized by the movement sensor automatically identifying movements of a person on the seat, or movements of the seat, and the evaluation device establishing from the identified movements a seat movement profile and/or control commands for a computer.

### CROSS-REFERENCE TO RELATED APPLICATIONS

This application claims the benefit of German Patent Application No. DE 10 2014 114 459.7, filed Oct. 6, 2014, and incorporated herein by reference.

### FIELD OF THE INVENTION

The invention relates to a combination comprising a seat, a portable device which comprises a movement sensor and an evaluation device. The invention further relates to a method for producing a seat movement profile of a person on a seat and/or control commands for a computer.

### BACKGROUND OF THE INVENTION

It is known from DE 10 2006 040 536 A1 to use an item of seating furniture to control machines or computers. The seating furniture which may in particular be constructed in the form of a stool has a frame which is provided for fixed positioning on a substrate and a seat member which is connected to the frame in a pivotable and rotatable manner. As a result of body weight displacements of a person seated on the seating furniture, the seat member can be pivoted and rotated relative to the frame, which is intended to be detected mechanically by means of sensors integrated in the seating furniture or optically by means of light scanning. The detected movements of the seat member relative to the frame may then be translated into control commands for the machines or the computer.

The publication “Recognizing static and dynamic sitting behavior by means of instrumented office chairs” by Schwartz et al. describes the development of an “active office” which, as a result of the configuration thereof with a standing work station, a seated work station and an “active” seat is intended to encourage a user towards increased physical activity as a result of a regular change of the body posture and body position. The active seat in this instance is intended to enable the detection and evaluation of the seat behaviour of the user. To this end, the seat itself is provided with sensors which detect movements of a seat member relative to a frame of the seating furniture.

It is disadvantageous that, for the detection and evaluation of the seat behaviour, a seat which is provided with sensors in a complex manner is required. This is linked with correspondingly high costs.

It is further disclosed in DE 10 2007 028 686 A1 to record a movement profile of a person using, for example, a movable device which comprises a movement sensor, to compare it with a target movement profile and to derive an activity index therefrom.

Based on this prior art, an object of the invention is to provide a possibility for being able to detect and evaluate the sitting behaviour of a user on a seat in the most cost-effective manner possible.

This object is achieved both by a combination of a seat, a portable device which comprises at least one movement sensor and an evaluation device according to claim 1 and by a method according to claim 21. The dependent claims relate to advantageous configurations of the combination according to the invention and corresponding embodiments of the method according to the invention which will be appreciated from the following description of the invention.

### SUMMARY OF THE INVENTION

The invention is based on the recognition that a seated behaviour of a person on a seat is characterised by movements of the person himself and it is therefore rather disadvantageous to draw conclusions relating to these movements of the person indirectly by the identification and evaluation of movements of a seat member relative to a frame of the seat resulting from movements of the person. Instead, it may be advantageous to identify the movements of the person himself.

Another recognition on which the invention is based is that, in the meantime, in order to identify movements of a person on a seat, a large number of suitable devices are available at low cost and are also so small and light that they can also be carried by the person whilst sitting on the seat without significant disruption for the person. This applies in particular to mobile telephones, which have been provided in the meantime to a great extent with both satellite-supported location sensors (for example, for GPS, GLONASS and/or the Galileo system) and other movement sensors, in particular acceleration sensors. Another advantage of a use, for example, of mobile telephones for identifying movements of a person is that a large proportion of the people who are considered to be users already have one.

Based on this basic notion, the invention therefore makes provision for a combination comprising a seat, a device which can be carried by a person and which is in particular intended to be carried and which comprises at least one movement sensor, and an evaluation device, wherein the movement sensor identifies seat-guided movements of the person or movements of the seat itself (that is to say, at least establishes measurement values from which such movements can be derived) and the evaluation device establishes from the identified movements a seat movement profile and/or control commands for a computer.

In a corresponding method according to the invention for producing a seat movement profile of a person on a seat and/or for controlling a computer, there is provision, by means of a device which can be carried by the person and which is in particular carried, for seat-guided movements of the person or movements of the seat itself to be identified, and for the seat movement profile and/or control commands for the computer to be established therefrom.

The term “seat movement profile” is intended according to the invention to be understood to be any evaluation of signals of the movement sensor, in which a conclusion is specifically drawn with respect to at least one movement which is guided and/or carried out by the seat.

An inertial sensor (in particular an acceleration sensor and/or rotation rate sensor) can preferably be used as a movement sensor. An advantage is that such an inertial sensor enables a movement recognition without an external reference point (that is to say, arranged outside the device to be carried and in particular also not carried by the person).

However, it is also possible to use a movement sensor which is integrated in the device and which operates in combination with an external reference point. As long as an adequate location precision can be achieved, it would therefore also be possible to use, for example, a satellite-supported location sensor as a movement sensor.

It is possible to consider as a computer which can be controlled by the evaluation of the movements of the person on the seat or the seat itself in particular a PC (“personal computer”), that is to say, a computer (which is independent of the operating system used) which is used by a person in particular for working and/or for entertainment purposes (that is to say, the term “PC” is also intended to include games consoles, smart TVs, etcetera) and which can in particular be personally configured with particular regard to the software which can be used. The computer may also be a control computer for a machine, for example, an industrial processing machine or a vehicle.

The term “seat” is intended according to the invention to be understood to be any seat which is provided specifically for the purposes of supporting a person in a seated position. In this instance, it may in particular be an item of seating furniture, for example, an office chair, in particular an office swivel chair, armchair, sofa, chair, stool or a fixedly installed seat, such as, for example, a vehicle seat. It is particularly preferred to use an office (swivel) chair for a combination according to the invention and for carrying out the method according to the invention since a large number of people spend several hours per (working) day seated on such an office chair and the resultant relatively static and one-sided loads on the body are considered to be at least partially responsible for a large number of so-called lifestyle illnesses, for example, back complaints. An establishment of a seat movement profile of a person on an office (swivel) chair may therefore be found to be particularly informative.

Furthermore, office (swivel) chairs (and also other seats) are currently mostly constructed in such a manner that a seat member is connected therein to a frame so as to be able to be displaced along one or more axes and/or so as to be able to be rotated about one or more axes. In this instance, movements of the seat member relative to the frame along and/or about these axes may in particular be the direct result of body displacements of the persons seated thereon. The movements sometimes have to be applied counter to restoring forces which are produced by the movements. As a result of a movable configuration of seats, movement activities of the persons are intended to be promoted during seating.

Such a movability of office (swivel) chairs and other seats may advantageously be used to improve the precision of the seat movement profile which is intended to be established and/or the control commands which are intended to be established by the identified movements of the person being associated with corresponding abilities of the seat member to move relative to the frame. Accordingly, there may preferably be provision, when the seat movement profile and/or the control commands are established, for only such identified movements along and/or about the (movement) axes of the seat to be taken into account. There may also be provision for identified movements of the person to be associated with assumed movements of the seat member relative to the frame along one or more and/or about one or more of these axes, wherein (possibly also only) these assumed movements are included in the seat movement profile.

In a particularly preferred manner, there may be provision for inclination movements about a sagittal axis, a transverse axis and/or a longitudinal axis of the person and/or about movement axes of the seat which are coaxial or parallel with these axes to be identified and to be used to establish the seat movement profile. In this instance, the inclination movements may be incorporated in particular as a path sum and/or angular sum in the seat movement profile.

There may further be provision for scatterings of the movements about the neutral positions of the seat to be included in the seat movement profile. The term “neutral positions” of the seat is intended to be understood to refer to the orientations of the seat member with respect to the movability axes which the seat member independently assumes relative to the frame in the state in which it is not loaded by the person.

In a preferred embodiment of the combination according to the invention, there may be provision for the evaluation device to be integrated in the device or the computer. It is possible to dispense with the provision of a separate evaluation device when the processing capacity of the device or the computer is itself used for the evaluation. The financial expenditure for the production of a combination according to the invention and carrying out a method according to the invention can thereby be kept low.

In another preferred embodiment of the combination according to the invention and a corresponding embodiment of the method according to the invention, there may be provision for a period of uninterrupted use of the seat by the person or a calendar period (for example, hour, day, week, month and/or year) to be defined as an establishment period for a seat movement profile.

There may further be provision for the seat movement profile to be output in the form of an evaluation which summarises the establishment period. The evaluation may, for example, be in the form of an evaluation number within a predefined evaluation number range. The seat movement profile of the person can thereby be provided in a manner which can be simply recorded and compared.

In a development of this embodiment of the combination according to the invention or the method according to the invention, there may also be provision, when a value falls below and/or exceeds one or more limit values of the evaluation, for a signal (for example, signal noise, vibration alarm) to be output. It is thereby possible in particular to attempt to encourage the person to increased movement activity on the chair.

There may further be provision for the evaluation to comprise a metabolic equivalent. Such a metabolic equivalent enables, in particular independently of physical data of the person, a comparison of the movement intensity whilst seated on the seat with movement intensities of other activities, in particular everyday activities (for example, currently sitting: x; walking: 2.0; running/walking: 3.5, etc).

There may preferably be provision for an identification of an occurrence of a use of the seat by the person to be carried out on the basis of the identification of specific movements by means of the evaluation device. It is thereby possible, in particular when a seat movement profile is established over a calendar time period, to prevent or reduce an influence of the seat movement profile as a result of movements of the person who does not make them whilst seated, for example, because he has in the meantime stood up from the seat. This embodiment of the combination according to the invention or the method according to the invention also enables an automatic start and/or an automatic ending of the production of the seat movement profile. This may in particular be advantageous in the production of a seat movement profile in the context of a defined calendar period.

An identification of a use of the seat with reference to specific movements may also be used to limit the production of the seat movement profile in that only movements of the person on specific seats are taken into account. To this end, the identification by means of which conclusions are intended to be drawn relating to the use of the seat can be based on specific movements which are enabled or supported by the corresponding seat. For example, a frequent and/or extensive rotation (that is to say, carried out about a relatively large angular range) of the person about his sagittal axis can indicate the use of an office (swivel) chair and thereby enable the production of the seat movement profile to be limited to the use of swivel chairs or the use thereof to be excluded when the seat movement profile is produced.

An identification of a use of the seat by the user can also be achieved by the seat having a corresponding use sensor. The identification of a use of the seat may, for example, be based on an establishment of the distance between the use sensor and the device (for which this may comprise a complementary sensor). In particular there may be provision for a value falling below a limit value for the distance to indicate the use of the seat by the person. A possible advantage of the use of such a distance sensor device may be that the use sensor which is integrated in the seat may be constructed in a passive manner, for example, as a reflector for signals transmitted by the complementary sensor of the device, whereby the sensor can be constructed, on the one hand, in a simple and cost-effective manner and, on the other hand, so as to operate without any energy supply.

However, the use sensor can also enable identification of a use of the seat in another manner. For example, it can identify a (weight) loading of the seat by the person.

In particular with such an active use sensor, there may be provision for it to be connected to the evaluation device so as to transmit signals, preferably in a wireless manner (for example, by means of radio signals).

In another preferred embodiment of the combination according to the invention and/or the method according to the invention, there may also be provision for a statistical variance of the movements identified in the establishment time period to be included in the seat movement profile.

There is further also the advantageous possibility of including a temporal distribution of the movements identified in the establishment time period in the seat movement profile.

Another advantageous possibility of providing a meaningful seat movement profile may involve an averaged acceleration of the movements identified in the establishment time period being included in the seat movement profile.

It is also possible to identify occurrences of asymmetry in the movements and to include them in the movement profile. This can enable a work station at which the person is occupied sitting on the seat for relatively long periods of time to be optimised in such a manner that the seat movement profile is characterised by movement sequences which are as symmetrical as possible, that is to say, movements which are as identical in terms of total and/or amplitude in both directions about at least one or along one movability axis.

In another preferred embodiment of the combination according to the invention, there may be provision for the seat to have a retention device for releasably fixing the device. This enables the establishment of a seat movement profile without the person being forced to carry the device (permanently). With the device which is fixed in the retention device, there may then also optionally be provided a conductor-guided signal-guiding connection between the device and a use sensor which is optionally integrated in the seat. The retention device can bring about the fixing of the device, for example, by means of a plug type and/or catch connection.

The indefinite articles (“a”, “an” and “of a” and “of an”) in particular in the claims and in the description which generally explains the claims, are intended to be understood as such and not as numerals. Components which are accordingly specified thereby are consequently intended to be understood in such a manner that they are present at least once and may be present several times.

### BRIEF DESCRIPTION OF THE DRAWINGS

The invention is explained in greater detail below with reference to an embodiment which is illustrated in the drawings, in which:

FIG. 1 shows a work station seat which comprises a combination according to the invention with a person seated thereon;

FIG. 2 is a side view of the person on a seat of the work station seat in the position inclined backwards;

FIG. 3 is a rear view of the person on the seat; and

FIG. 4 is a view according to FIG. 3 with a lateral body displacement of the person.

### DETAILED DESCRIPTION OF ILLUSTRATIVE EMBODIMENTS

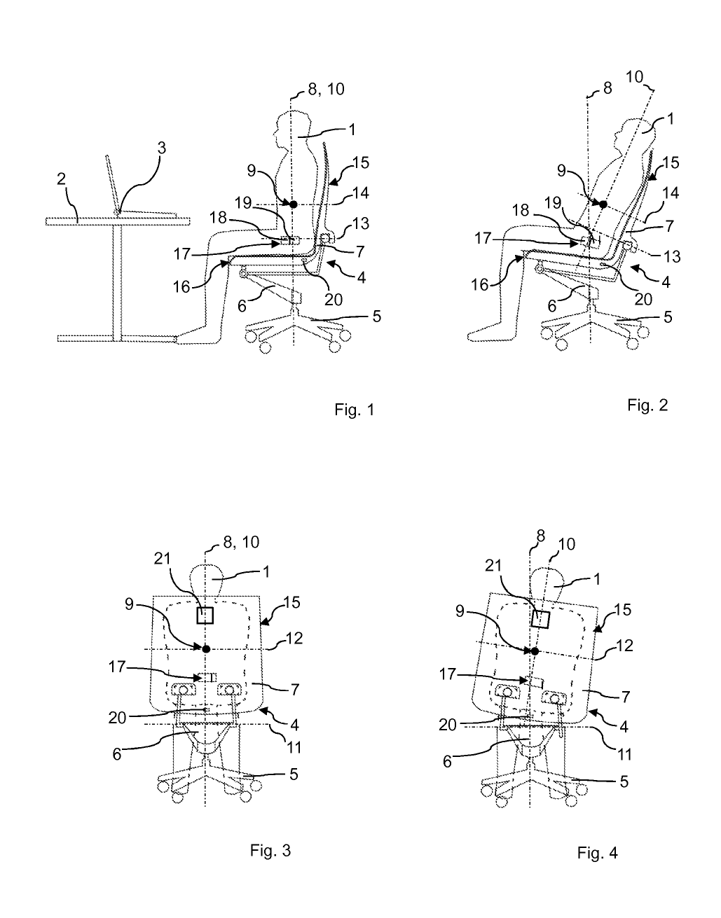

FIG. 1 shows a work station seat for a person 1 having a desk 2, a computer 3 which is located on the desk 2 and a seat 4 in the form of an office swivel chair. The person 1 is seated on the chair 4.

The seat 4 comprises a frame 5, a seat mechanism 6 and a seat member 7. The seat member 7 is supported together with the seat mechanism 6 so as to be able to be rotated about a first vertical rotation axis 8 with respect to the frame 5. This vertical rotation axis 8 extends substantially coaxially or parallel with a longitudinal axis 10 which extends through the centre of gravity of the body 9 (in the region of the upper body) of the person 1. The seat mechanism 6 also enables pivoting of the seat member 7 about a second horizontal rotation axis 11 which extends parallel with a transverse axis 12 of the person 1, which axis extends through the centre of gravity of the body 9 (cf. FIGS. 1 and 2). Furthermore, the seat mechanism 6 enables pivoting of a backrest 15 of the seat member 7 about a third rotation axis 13 which extends substantially perpendicularly to the other two rotation axes 8, 11 and consequently substantially parallel with a sagittal axis 14 of the person 1, which axis extends through the centre of gravity of the body 9 (cf. FIGS. 3 and 4). The pivoting of the backrest 15 of the seat member 7 is enabled in this instance by a correspondingly torsionally flexible configuration of a seat face 16 of the seat member 7.

The person 1 carries, for example, in a trouser pocket, a device 17 having a movement sensor 18. The device 17 may in particular be a mobile telephone. There is installed on the device 17 a software application which can be started by the person 1 when he wishes to produce a seat movement profile. However, when the device 17 is switched on, the software application can also permanently be in standby mode and does not then have to be started manually by the person 1.

Movements which the person 1 carries out on the seat 4 are detected by the movement sensor 18. With reference to corresponding signals of the movement sensor 18, a seat movement profile is produced by an evaluation device 19 of the device 17. Alternatively or additionally, using the movements detected by the movement sensor 18, corresponding control commands can also be determined for the computer 3, for example, in order to control a computer game which is installed on the computer 3. The evaluation device 19 of the device 17 can be constructed in such a manner that it uses a main processor and a main store of the device 17. The main processor may further carry out the processing operations required for operation of the device 17. The operating software of the device 17 can further be stored on the main store.

Another use sensor 20 is integrated in the seat. This is preferably constructed in a passive manner and cooperates with a sensor of the device 17. For example, the sensor of the device 17 can in conjunction with the use sensor 20 of the seat 4 establish the distance relative thereto and derive therefrom a use of the seat 4 by the person 1. The establishment of the seat movement profile and/or the control commands can thereby be automatically started when the person 1 sits on the seat 4. The use sensor 20 also enables automatic interruption of the establishment of the seat movement profile and/or the control commands when the person 1 stands up from the seat 4. It is thereby possible to avoid distortion of the seat movement profile resulting from movements of the person 1 which he does not carry out when seated on the seat 4. The establishment and carrying out of undesirable control commands for the computer 3 can also be avoided.

The seat 4 has, for example, at the rear side of the backrest 15, a retention device 21 for the device 17, in which it can be inserted by the person 1. This enables the establishment of the seat movement profile and/or the control commands even when the person 1 does not wish to carry the device 17. In this instance, the movements of the seat 4 are detected by the movement sensor of the device 17. The movements of the person 1 which bring about those movements of the seat 4 can then be derived therefrom.

### REFERENCE NUMERALS

1 Person
2 Desk
3 Computer
4 Seat
5 Frame
6 Seat mechanism
7 Seat member
8 First rotation axis
9 Centre of gravity of body
10 Longitudinal axis
11 Second rotation axis
12 Transverse axis
13 Third rotation axis
14 Sagittal axis
15 Backrest
16 Seat face
17 Device
18 Movement sensor
19 Evaluation device
20 Use sensor
21 Retention device

1. In combination, a seat and a portable device including at least one movement sensor and an evaluation device, the combination characterised in that the movement sensor identifies seat-guided movements of a person or the seat and the evaluation device establishes from the identified movements a seat movement profile and/or control commands for a computer.

2. The combination according to claim 1, characterised in that the evaluation device is integrated in the device or the computer.

3. The combination according to claim 1, characterised in that a period of uninterrupted use of the seat by the person or a calendar period is defined as an establishment period for the seat movement profile.

4. The combination according to claim 3, characterised in that the seat movement profile is output in the form of an evaluation which summarises the establishment time period.

5. The combination according to claim 4, characterised in that, when a value falls below and/or exceeds one or more limit values of the evaluation, a signal is output.

6. The combination according to claim 4, characterised in that the evaluation comprises a metabolic equivalent.

7. The combination according to claim 1, characterised in that an identification of a use of the seat by the person is carried out by means of identification of specific movements.

8. The combination according to claim 1, characterised in that the seat has a use sensor for identification of a use of the seat by the person.

9. The combination according to claim 8, characterised in that the use sensor is connected to the evaluation device so as to transmit signals.

10. The combination according to claim 8, characterised in that the distance between the use sensor and the device can be established by means of the use sensor.

11. The combination according to claim 1, characterised in that inclination movements about a sagittal axis, a transverse axis and/or a longitudinal axis of the person are identified and used to establish the seat movement profile and/or the control commands.

12. The combination according to claim 11, characterised in that the inclination movements are established as a path sum and/or angular sum.

13. The combination according to claim 3, characterised in that a statistical variance of the movements identified in the establishment time period is included in the seat movement profile.

14. The combination according to claim 3, characterised in that a temporal distribution of the movements identified in the establishment time period is included in the seat movement profile.

15. Combination according to claim 3, characterised in that an averaged acceleration of the movements identified in the establishment time period is included in the seat movement profile.

16. The combination according to claim 1, characterised in that occurrences of asymmetry in the movement sequences are identified and included in the seat movement profile.

17. The combination according to claim 1, characterised in that the seat has a seat member and a frame which can be displaced along one or more axes and/or which are rotatably connected to each other about one or more axes.

18. The combination according to claim 17, characterised in that, when the seat movement profile is established, only movements along and/or about the axis/axes are taken into account and/or identified movements of the person are associated with assumed movements of the seat member relative to the frame along and/or about this/these axis/axes and these assumed movements are included in the seat movement profile.

19. The combination according to claim 18, characterised in that scatterings of the movements about the neutral positions of the seat are included in the seat movement profile.

20. The combination according to claim 1, characterised in that the seat has a retention device for releasably fixing the device.

21. A method for producing a seat movement profile of a person on a seat and/or for controlling a computer, wherein, by means of a device which is carried by the person, seat-guided movements of the person or the seat are identified and the seat movement profile and/or the control commands is/are established therefrom.
